(19) United States
(12) Patent Application Publication
(10) Pub. No.: US 2011/0240658 A1
(43) Pub. Date: Oct. 6, 2011

(54) CONTAINER WITH INTERLOCKING CONFIGURATION

(76) Inventor: James R. Marnocha, Appleton, WI (US)

(21) Appl. No.: 12/754,868

(22) Filed: Apr. 6, 2010

(51) Int. Cl. B65D 8/04; B31B 1/26

(52) U.S. Cl. 220/604; 493/162

(57) ABSTRACT

A container, in a preferred form, includes a support member having a support surface, a first side that extends away from the support member and defines a first foot that is adjacent the support surface and that has a first face, and a second side that extends away from the support member and defines a second foot that is adjacent the support surface and that has a second face. When the first foot abuts the second foot, the first face and second face interlock to inhibit relative movement between the first foot and the second foot.

### CROSS REFERENCES TO RELATED APPLICATIONS

Not applicable.

### STATEMENT REGARDING FEDERALLY SPONSORED RESEARCH

Not applicable.

### BACKGROUND

The present disclosure relates generally to a container formed from a foldable blank having an interlocking configuration. More particularly, the disclosure describes a formed container having abutting and interlocking feet that help secure the container in the folded form.

Many containers (used broadly herein to include lids, covers, trays, cartons, boxes, and the like) are formed from a foldable blank. The blank may be made of paperboard, cardboard (single walled, doubled walled, etc.), plastic, or any other suitable material, or combination of materials, which allow the blank to be folded into the desired container.

In an effort to fold the blanks as efficiently as possible, machines have been developed to mechanically fold the blank into the final container form. For instance, Kliklok-Woodman manufactures various machines that can fold blanks into containers with varying degrees of autonomy.

Another aspect of efficient forming involves the reduction or elimination of adhesives used to secure the container in the folded form. Adhesives add cost and complexity to the forming operation. One approach to maintain the container in final form without any, or significant amounts of, adhesives involves overlapping structures that undergo deformation to secure selected portions of the container, such as tab-in-slot arrangements.

Unfortunately, using overlapping structures to secure the container in the folded form in lieu of, or in addition to, adhesives places further demands on the machine used during the forming operation. Generally, these overlapping structures require more sophisticated and complex machines, and may increase the average time required to form a container from a blank.

One approach to eliminate the issues associated with overlapping structures has been to rely upon friction between various adjacent portions of the container to secure the container in the final form. For example, a container 100 is shown in FIG. 1 having a support member 102 with a first side 104 and a second side 106 extending upward from a support surface 108. The first side 104 includes a first outer wall portion 110 that is folded over to define a first inner wall portion 112. Similarly, the second side 106 includes a second outer wall portion 114 that is folded over to define a second inner wall portion 116. Both the first inner wall portion 112 and the second inner wall portion 116 extend toward the support surface 108 where a first foot portion 118 and a second foot portion 120 are respectively formed by folding.

As shown in FIG. 1, the first foot portion 118 and second foot portion 120 engage at an interface 122 near a corner 124 that is defined by the folded first side 104 and second side 106. When adhesive is not used to secure the first foot portion 118 and the second foot portion 120 in place, a plane of contact defined at the interface 122 is relied upon to inhibit relative movement between the first foot portion 118 and the second foot portion 120. As shown in FIG. 1, the interface 122 is generally formed at a forty-five degree angle relative to the first inner wall portion 112 and the second inner wall portion 116 by the abutting ends of the first foot portion 118 and the second foot portion 120 being angled accordingly. In some circumstances, this interface does not sufficiently inhibit relative movement between the first foot portion 118 and the second foot portion 120, and thus the final folded form of the container is not always maintained during use.

In light of at least the above considerations, a need exists for an improved container formed from a foldable blank that is capable of being secured in the folded form without requiring often costly, complex, and cumbersome overlapping structures or adhesives.

### SUMMARY

In one aspect, a container comprises a support member having a support surface. A first side extends away from the support member and defines a first foot that is adjacent the support surface and that has a first face. A second side extends away from the support member and defines a second foot that is adjacent the support surface and that has a second face. When the first foot abuts the second foot, the first face and second face interlock to inhibit relative movement between the first foot and the second foot.

In another aspect, a container comprises a support member having a support surface. A first side extends away from the support member and is folded to define a first foot adjacent the support surface that has a first face. A second side extends away from the support member and is folded to define a second foot adjacent the support surface that has a second face. An interface is defined by the first face and the second face when the first face abuts the second face, and extends between a first end and a second end. The interface is contoured between the first end and the second end such that the first face and second face interlock to inhibit relative movement between the first foot and the second foot.

In yet a further aspect, a method of folding a container from a blank that defines a support member having a support surface, a first side having a first outer wall portion extending away from the support member along a first inner wall portion toward a first foot portion, and a second side having a second outer wall portion extending away from the support member along a second inner wall portion toward a second foot portion, comprises: folding the first outer wall portion substantially perpendicular to the support surface; folding the second outer wall portion substantially perpendicular to the support surface; folding the first inner wall portion substantially parallel with the first outer wall portion; folding the second inner wall portion substantially parallel with the second outer wall portion; folding the first foot portion substantially perpendicular to the first inner wall portion; folding the second foot portion substantially perpendicular to the second inner wall portion; and abutting the first foot portion and the second foot portion at an interface that is contoured to interlock the first foot portion and the second foot portion thereby inhibiting relative movement between the first foot portion and the second foot portion.

These and still other aspects of the invention will be apparent from the description that follows. In the detailed description, preferred example embodiments will be described with reference to the accompanying drawings. These embodiments do not represent the full scope of the invention; rather, the invention may be employed in many other embodiments. Reference should therefore be made to the claims for determining the full breadth of the invention.

### BRIEF DESCRIPTION OF THE DRAWINGS

FIG. 1 is a partial isometric cut-away view of a prior art container.

FIG. 2 is an isometric view of an example embodiment of a container.

FIG. 3 is a partial isometric cut-away view of the example container shown in FIG. 2.

FIG. 4 is a partial exploded view of the example container shown in FIG. 3.

FIG. 5 is top view of an example embodiment of a blank foldable into the container shown in FIG. 2.

FIG. 6 is a partial top view of a second example embodiment of a container.

FIG. 7 is a partial top view of a third example embodiment of a container.

FIG. 8 is a partial top view of a fourth example embodiment of a container.

FIG. 9 is a partial top view of a fifth example embodiment of a container.

### DETAILED DESCRIPTION OF THE PREFERRED EXAMPLE EMBODIMENT

Several example containers are described and illustrated; however, given the benefit of this disclosure, one skilled in the art will appreciate the various modifications that can be made to the example embodiments and yet remain within the scope of the claims.

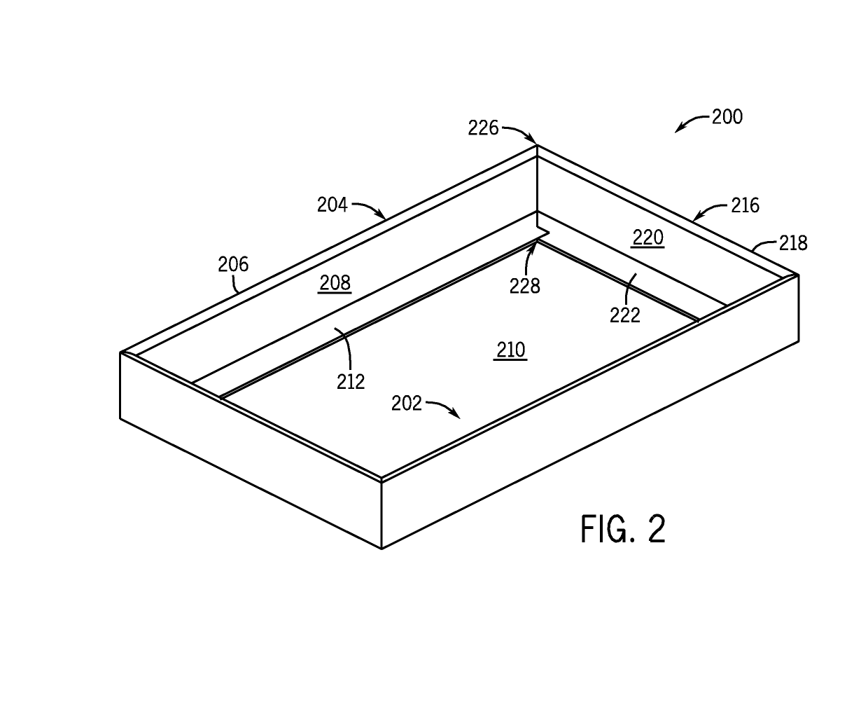

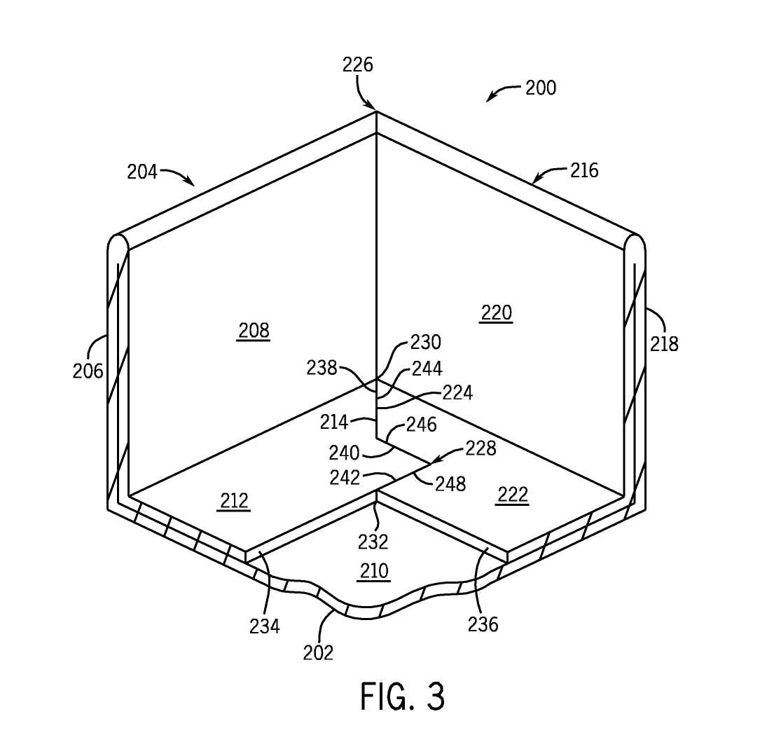

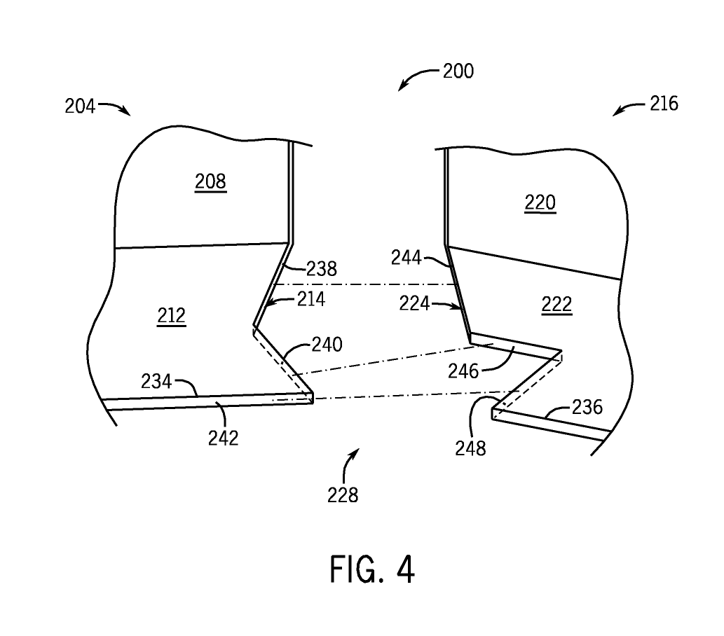

A container 200 is shown generally in FIGS. 2-4 and may be made of paper (e.g., paperboard, cardboard), plastic, or any other suitable material, or combination of materials, given particular application requirements; additionally, the thickness of the paper, plastic, or other material may be tailored for each particular container application. A support member 202 of the example container 200 includes a first side 204 extending upward (as generally viewed in FIG. 2) and away from the support member 202 along a first outer wall portion 206. The first side 204 is folded to define a first inner wall portion 208 extending back toward a support surface 210 of the support member 202. The first side 204 is folded inward to define a first foot 212 adjacent the support surface 210. As best shown in FIG. 4, the first foot 212 has a first face 214 that, in the example embodiment, is generally planar (albeit segmented) and oriented perpendicular to the support surface 210 (as shown in FIG. 3).

Similar to the first side 204, the support member 202 includes a second side 216 extending upward (as generally viewed in FIG. 2) and away from the support member 202 along a second outer wall portion 218. The second side 216 is folded to define a second inner wall portion 220 extending back toward the support surface 210 of the support member 202. The second side 216 is folded inward to define a second foot 222 adjacent the support surface 210. As best shown in FIG. 4, the second foot 222 has a second face 224 that, in the example embodiment, is generally planar (albeit segmented) and oriented perpendicular to the support surface 210 (as shown in FIG. 3).

With continued references to FIGS. 2-4, when the first side 204 and the second side 216 are folded to form a corner 226 of the container 200, the first foot 212 and second foot 222 abut at an interface 228. The interface 228 of the example embodiment extends between a first end 230 proximate the respective first inner wall portion 208 and second inner wall portion 220, and a second end 232 proximate distal ends 234, 236 of the respective first foot 212 and second foot 222.

The first face 214 of the first foot 212 and the second face 224 of the second foot 222 abut each other at the interface 228 without any substantial overlap. In the example shown in FIGS. 2-4, the first face 214 and the second face 224 are substantially perpendicular to the support surface 210. This perpendicular configuration is generally consistent with die-cutting operations, as is understood by one of ordinary skill in the art.

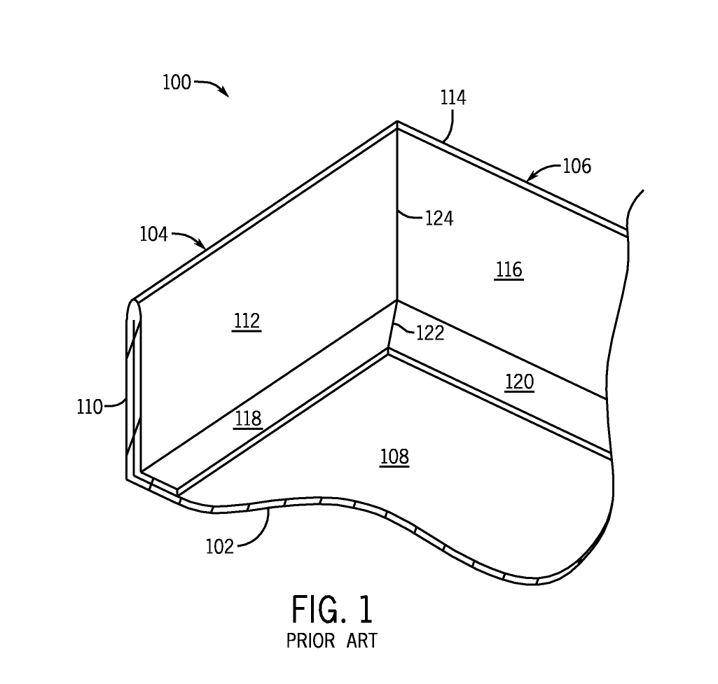

When the first foot 212 abuts the second foot 222, the first face 214 and the second face 224 abut at the interface 228 and “interlock” to inhibit relative movement between the first foot 212 and the second foot 222 at the interface 228. In the example shown in FIGS. 2-4, the interlock is achieved by the interface 228 being contoured between the first end 230 and the second end 232 such that the first face 214 and the second face 224 abut and are inhibited from sliding along any one plane radiating from the corner 226. This configuration is opposed to the configuration shown in FIG. 1 of prior art container designs wherein the interface 122 does not “interlock” and allows relative movement between the first foot 118 and the second foot 120 along the plane radiating from the corner 124.

With specific reference to the example container 200 illustrated in FIGS. 2-4 (and as best shown in FIG. 4), the first face 214 and the second face 224 define segments that establish the contour of the interface 228, thereby interlocking the first face 214 and the second face 224 and inhibiting relative movement between the first foot 212 and the second foot 222. The first face 214 of the first foot 212 includes (relative to the first side 204) a first angled segment 238, a first perpendicular segment 240, and a first parallel segment 242. Similarly, the second face 224 of the second foot 222 includes (relative to the second side 216) a second angled segment 244, a second parallel segment 246, and a second perpendicular segment 248. Abutting the first face 214 and the second face 224 interlocks the first foot 212 and the second foot 222 as the first angled segment 238 and the second angled segment 244 abut, the first perpendicular segment 240 and the second parallel segment 246 abut, and the first parallel segment 242 and the second perpendicular segment 248 abut.

Thus, the resulting interface 228 includes a segment that is parallel to the first side 204 and simultaneously perpendicular to the second side 216, and a segment that is parallel to the second side 216 and simultaneously perpendicular to the first side 204. Furthermore, in the preferred form, both the first foot 212 and the second foot 222 are oriented parallel to the support surface 210 such that first foot 212 and the second foot 222 contact the support surface 210 when in the folded orientation shown in FIGS. 2 and 3. The interlock established by the contoured interface 228 does not require overlap between the first foot 212 and the second foot 222 or require the use of adhesive (or any other fastener).

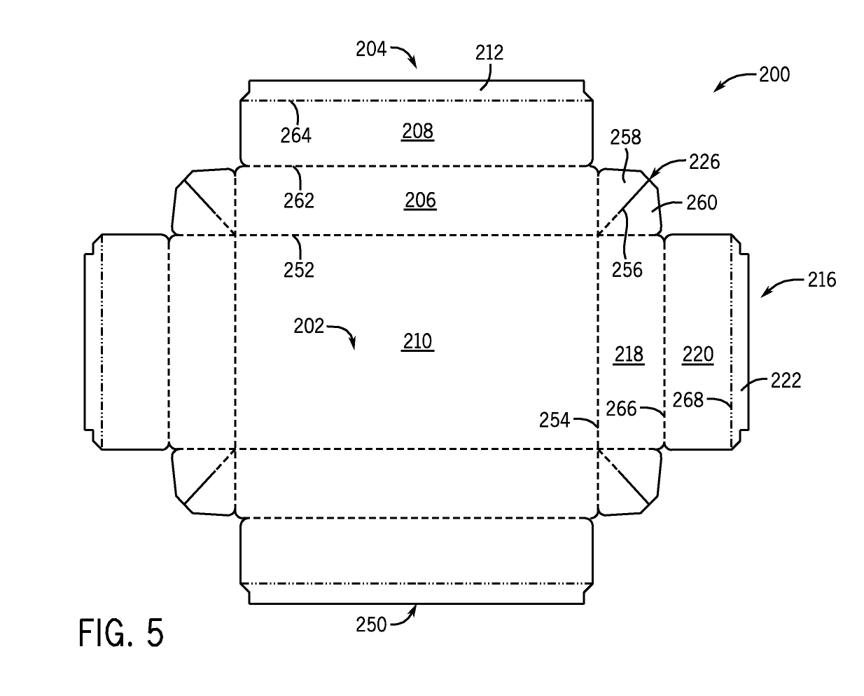

One technique to form the example container 200 illustrated in FIG. 2 involves folding a blank 250 (as shown unfolded in FIG. 5) into the form of the final container 200. The blank 250 may be die cut from stock material into the shape of the blank 250 shown in FIG. 5. Additional perforations may be formed in the blank 250, as is understood by one of ordinary skill in the art. As noted above, efficient forming operations may be aided by use of a folding machine, such as those designed and manufactured by Kliklok-Woodman. The non-overlapping, abutting, interlocking interface 228 is well suited for automated folding machines, and further does not require the use of any adhesive to secure the container 200 in the final folded form.

A method of folding the container 200 will be described with reference to a single corner 226, and one skilled in the art will understand, given the benefit of this disclosure, that the remaining container 200 is folded similarly. The folding is preferably performed in whole or in part by machine and is facilitated by the absence of overlapping portions and/or portions requiring adhesive.

The example blank 250 defines the support member 202 and support surface 210. The first side 204 includes the first outer wall portion 206 extending away from the support member 202 along the first inner wall portion 208 toward the first foot 212 portion. Similarly, the second side 216 includes the second outer wall portion 218 extending away from the support member 202 along the second inner wall portion 220 toward the second foot 222 portion. Also, a corner 226 portion extends between the first side 204 and the second side 216.

To form the container 200, the first outer wall portion 206 is folded along fold line 252 out of the page (with reference to FIG. 5) and substantially perpendicular to the support surface 210. Similarly, the second outer wall portion 218 is folded along fold line 254 out of the page and substantially perpendicular to the support surface 210. The corner 226 portion is also folded along the perforated fold line 256 forming a first triangular portion 258 and a second triangular portion 260 that overlap and fold adjacent either the first outer wall portion 206 or the second outer wall portion 218.

With the first outer wall portion 206 folded substantially perpendicular to the support surface 210, the first inner wall portion 208 is folded inward along fold line 262 to be substantially parallel with the first outer wall portion 206. The first foot 212 portion is also folded inward along perforated fold line 264 to be substantially perpendicular to the folded first inner wall portion 208. Thus, the first foot 212 is positioned adjacent and generally parallel to the support surface 210 when folded.

With the second outer wall portion 218 also folded substantially perpendicular to the support surface 210, the second inner wall portion 220 is folded inward along fold line 266 to be substantially parallel with the second outer wall portion 218. The second foot 222 portion is also folded inward along perforated fold line 268 to be substantially perpendicular to the folded second inner wall portion 220. Thus, the second foot 222 is also positioned adjacent and generally parallel to the support surface 210 when folded.

The above folding results in the first foot 212 and the second foot 222 abutting at the interface 228 such that the contours of the interface 228 interlock to inhibit relative movement between the first foot 212 and the second foot 222. For instance, as described with reference to FIGS. 2-4, the interface 228 may include various segments that are oriented parallel or perpendicular to the first side 204 and the second side 216 to inhibit relative movement between the first foot 212 and the second foot 222. Of course, the order of the above folds may be altered as desired or required by any particular container application requirement.

As one skilled in the art will appreciate, given the benefit of this disclosure, various other configurations and arrangements are available to interlock and thus inhibit relative movement between the feet when in the folded container form. Generally, the interface is contoured to interlock and inhibit relative movement of the feet along any single line radiating from the corner. For comparison, the prior art configuration shown in FIG. 1 does not include an interface that interlocks, instead the first foot 118 and the second foot 120 engage at the interface 122 along a flat plane radiating from the corner 124, which allows the first foot 118 and the second foot 120 to move relative to the other.

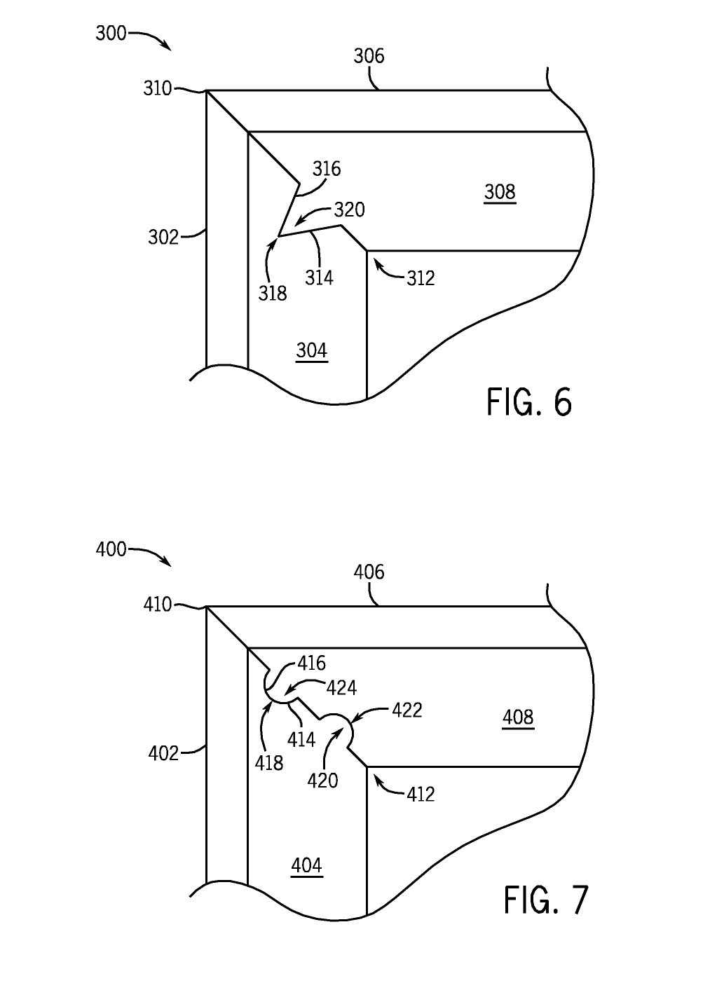

A second example embodiment of a container 300 including an interlock is generally illustrated in FIG. 6. Specifically, a first side 302 includes a first foot 304 and a second side 306 includes a second foot 308. The first foot 304 and the second foot 308 abut at a corner 310 and define an interface 312 at which a respective first face 314 of the first foot 304 and a second face 316 of the second foot 308 abut and interlock. In this example embodiment, the first face 314 includes and defines a recessed segment 318 of the interface 312 and the second face 316 includes and defines a protruded segment 320 of the interface 312. As viewed in FIG. 6, the first face 314 and second face 316 define a generally V-shaped contour that interlocks to inhibit relative movement between the first foot 304 and the second foot 308 along the interface 312.

A third example embodiment of a container 400 having an interlock is generally illustrated in FIG. 7. In this embodiment, a first side 402 includes a first foot 404 and a second side 406 includes a second foot 408. The first foot 404 and the second foot 408 abut at a corner 410 and define an interface 412 at which a respective first face 414 of the first foot 404 and a second face 416 of the second foot 408 abut and interlock. The first face 414 includes and defines a recessed arcuate segment 418 of the interface 412 and a protruded arcuate segment 420 of the interface 412. The second face 416 includes and defines a mating recessed arcuate segment 422 of the interface 412 and a mating protruded arcuate segment 424 of the interface 412. As viewed in FIG. 7, the first face 414 and second face 416 define a generally elongated S-shaped contour that interlocks to inhibit relative movement between the first foot 404 and the second foot 408 along the interface 412.

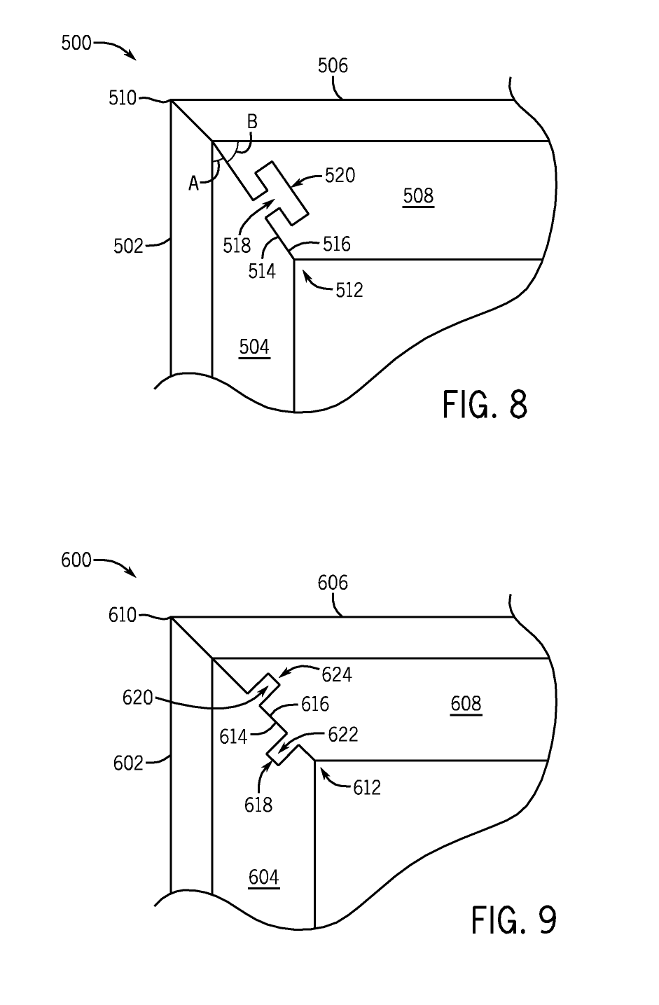

A fourth example embodiment of a container 500 including an interlock is generally illustrated in FIG. 8. Specifically, a first side 502 includes a first foot 504 and a second side 506 includes a second foot 508. The first foot 504 and the second foot 508 abut at a corner 510 and define an interface 512 at which a respective first face 514 of the first foot 504 and a second face 516 of the second foot 508 abut and interlock. In this example embodiment, as viewed in FIG. 8, the first face 514 includes and defines a T-shaped protruded segment 518 of the interface 512 and the second face 516 includes and defines a T-shaped recessed segment 520 of the interface 312. Abutting the first face 514 and the second face 516 abuts and interlocks the T-shaped protruded segment 518 and the T-shaped recessed segment 520 to inhibit relative movement between the first foot 504 and the second foot 508 along the interface 512.

The fourth example embodiment shown in FIG. 8 also illustrates that the first foot 504 and the second foot 508 may have different widths (as viewed in FIG. 8). In addition, the first face 514 may define an angle A relative to the first side 502 that is distinct from an angle B defined between the second face 516 and the second side 506. As shown in FIG. 8, the angle A defined by the first face 514 is less than the angle B defined by the second face 516. One skilled in the art will appreciate the various angles and configurations available for particular applications.

A fifth example embodiment of a container 600 having an interlock is generally illustrated in FIG. 9. A first side 602 includes a first foot 604 and a second side 606 includes a second foot 608. The first foot 604 and the second foot 608 abut at a corner 610 and define an interface 612 at which a respective first face 614 of the first foot 604 and a second face 616 of the second foot 608 abut and interlock. In this example embodiment, the first face 614 includes and defines a recessed segment 618 and a protruded segment 620 of the interface 612, and the second face 616 includes and defines a mating protruded segment 622 and a mating recessed segment 624 of the interface 612. As viewed in FIG. 9, the first face 614 and second face 616 define a generally castellated contour that interlocks to inhibit relative movement between the first foot 604 and the second foot 608 along the interface 612.

While there has been shown and described what is at present considered the preferred embodiments of the invention, it will be obvious to those skilled in the art that various changes and modifications can be made, given the benefit of this disclosure, without departing from the scope of the invention defined by the following claims.

We claim:

1. A container, comprising:
a support member having a support surface;
a first side extending away from the support member and defining a first foot adjacent the support surface having a first face; and
a second side extending away from the support member and defining a second foot adjacent the support surface having a second face;
wherein when the first foot abuts the second foot, the first face and second face interlock to inhibit relative movement between the first foot and the second foot.

2. The container of claim 1, wherein the first face includes a segment that is parallel to the first side and another segment that is perpendicular to the first side.

3. The container of claim 2, wherein the second face includes a segment that is parallel to the second side and another segment that is perpendicular to the second side.

4. The container of claim 1, wherein when the first foot abuts the second foot the first face and the second face are substantially perpendicular relative to the support surface.

5. The container of claim 1, wherein first face includes a recessed segment and the second face includes a protruded segment.

6. The container of claim 1, wherein the first face includes a first arcuate segment and the second face includes a second arcuate segment.

7. The container of claim 1, wherein:
the first wall and the second wall define a corner;
the first face defines a first angle relative to the first side;
the second face defines a second angle relative to the second side; and
the first angle is greater than the second angle.

8. The container of claim 1, wherein:
the first foot is oriented parallel to the support surface; and
the second foot is oriented parallel to the support surface.

9. A container, comprising:
a support member having a support surface;
a first side extending away from the support member and folded to define a first foot adjacent the support surface having a first face; and
a second side extending away from the support member and folded to define a second foot adjacent the support surface having a second face; and
an interface defined by the first face and the second face when the first face abuts the second face;
wherein the interface extends between a first end and a second end; and
wherein the interface is contoured between the first end and the second end such that the first face and second face interlock to inhibit relative movement between the first foot and the second foot.

10. The container of claim 9, wherein the interface is contoured to include a segment that is parallel to at least one of the first side and the second side and another segment that is perpendicular to at least one of the first side and the second side.

11. The container of claim 9, wherein the first face and the second face are substantially perpendicular relative to the support surface.

12. The container of claim 9, wherein the interface is contoured to include at least one arcuate segment.

13. The container of claim 9, wherein:
the first wall and the second wall define a corner;
the first face defines a first angle relative to the first side;
the second face defines a second angle relative to the second side; and
the first angle is greater than the second angle.

14. A method of folding a container from a blank defining a support member having a support surface, a first side having a first outer wall portion extending away from the support member along a first inner wall portion toward a first foot portion, and a second side having a second outer wall portion extending away from the support member along a second inner wall portion toward a second foot portion, comprising:
folding the first outer wall portion substantially perpendicular to the support surface;
folding the second outer wall portion substantially perpendicular to the support surface;
folding the first inner wall portion substantially parallel with the first outer wall portion;
folding the second inner wall portion substantially parallel with the second outer wall portion;
folding the first foot portion substantially perpendicular to the first inner wall portion;
folding the second foot portion substantially perpendicular to the second inner wall portion; and
abutting the first foot portion and the second foot portion at an interface that is contoured to interlock the first foot portion and the second foot portion thereby inhibiting relative movement between the first foot portion and the second foot portion.

15. The method of claim 14, wherein:
folding the first foot portion substantially perpendicular to the first inner wall portion further includes folding the first foot portion substantially parallel with the support surface; and
folding the second foot portion substantially perpendicular to the second inner wall portion further includes folding the second foot portion substantially parallel with the support surface.

16. The method of claim 14, wherein the contour includes a segment that is parallel to at least one of the first side and the second side and another segment that is perpendicular to at least one of the first side and the second side.

17. The method of claim 14, wherein the contour includes at least one arcuate segment.
